(19) United States
(12) Patent Application Publication
(10) Pub. No.: US 2004/0064505 A1
(43) Pub. Date: Apr. 1, 2004

(54) Method and device for setting up voice conferences

(76) Inventor: Johann Hartl, Bergkirchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/450,405

(22) PCT Filed: Dec. 8, 2001
(86) PCT No.: PCT/EP01/14435

(30) Foreign Application Priority Data
Dec. 14, 2000 (DE) 100 62 342.5

(51) Int. Cl. G06F 15/16

(52) U.S. Cl. 709/204

(57) ABSTRACT

A process is proposed for realizing teleconferences in a switchboard network with a number (N) of active conference participants (KT₁ . . . KT_{N}), who are connected to the switchboard network via one subscriber unit, in which the computation of the conference takes place in each subscriber unit, which forms one or more conference nodes (KK₁ . . . KK_{N}).

In this manner, special hardware is no longer required for teleconferences, and the maximum number of conferences and conference participants is no longer limited because each participant in the switchboard network can participate in a conference.

The invention relates to a process for realizing teleconferences in a switchboard network having a number of active conference participants who are connected to the switchboard network via subscriber units, and a device for implementing the process.

In this, several subscribers can be serviced in one subscriber unit, hence several conference nodes can exist in one subscriber unit.

In switchboard systems such as the EUROCOM MKS200 exchange, conference units (2×SIGPS+SIGPST) are established for the realization of teleconferences. In a conference in the MKS200 exchange, all participants are routed radially to this conference unit, so that the user channel data from the individual conference participants can be computed.

This results in the disadvantages that, on one hand, special hardware is necessary for teleconferences, and, on the other hand, the maximum number of conferences and conference participants is limited by the hardware.

It is the object of the invention to develop a process of the type described at the beginning and devices for implementing said process that will allow conferences to be conducted without the above-named limitations.

This is achieved according to the invention with the characterizing features disclosed in the characterizing portion of claim 1. Special hardware is no longer required for teleconferences, and the maximum number of conferences and conference participants is no longer limited, as each participant in the switchboard network can participate in a conference.

Details of the invention are found in the sub-claims and the description, in which one exemplary design is discussed in detail with reference to the drawings. These show

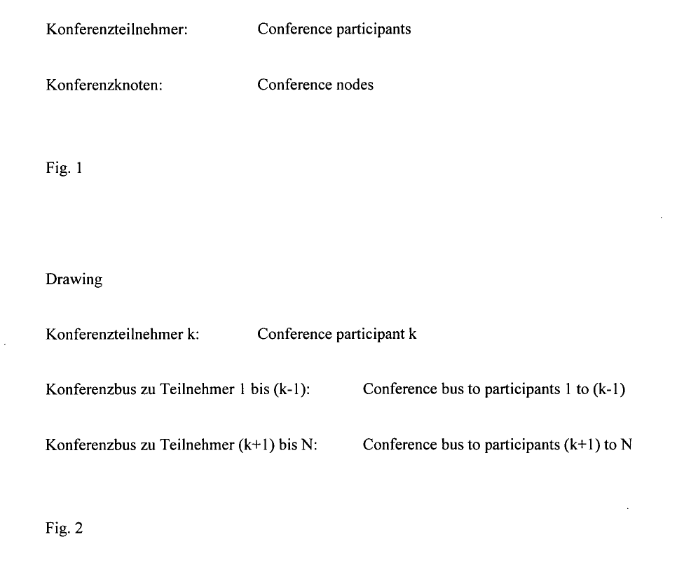

FIG. 1 a schematic representation of the structure of the conference and

FIG. 2 a schematic representation of the structure of the conference node.

According to FIG. 1, the individual conference participants KT₁ . . . KT_{N} are connected to their conference nodes KK₁-KK_{N}. In the conference nodes the computation of the conference takes place. These nodes are realized in the subscriber units in the form of signal processor programs DSP. The conference nodes themselves are connected to one another and to a conference bus KB.

For the following sections the following applies:

| | |
|---|---|
| Conference participants: | 1 − N |
| Current conference nodes: | 1 ≦ k ≧ N. |

The core of the conference is the section in the conference nodes in which the user channel data from the conference participants can be blended. In this regard please refer to FIG. 2.

The computation is designed such that in the conference buses all the participants will always transmit or receive at the same levels.

In the conference node KTₖ, for the kth conference participant KTₖ, the useful signal from the conference buses, with the corresponding weighting of the number N of participants who are on the bus, is removed, added up, and routed to the participant KTₖ. Similarly, the signal of the participant KTₖ on the conference bus is added with the corresponding weighting, so that the individual participants who are already available on the bus are present with the same weighting. In order that the maximum level in the conference bus will not be exceeded, the bus signal must be correspondingly adjusted in each conference node.

For concrete realization, in the known MKS exchange system two types of conference buses are available. They differ in terms of the voice quality they are capable of transmitting, and the network load that they produce. The type of conference bus also influences the structure of the programs in the individual conference nodes.

64 k Bit MTS Conference Bus:

Via the 64-kbit MTS connection, 8 Bit PCM values (A-Law) are transmitted. From the transmission rate and the 8 Bit words, a sample rate of 8 kHz is derived. To compute the conference, the useful information from all participants must be adjusted to this 8 kHz structure. This results in the advantage of high voice quality, however this is offset by a correspondingly high network load.

32 kbit DCDM Conference Bus:

The 32 kbit DCDM conference bus connects the conference nodes via a standard DCDM connection. From the DCDM samples, PCM values are formed using a transcoding algorithm. These transcoded PCM values are also present with the sample rate of 32 kHz. To compute the conference, the useful data from all participants must be adjusted to this 32 kHz structure. This results in the advantage of a low network load, however this is offset by poorer voice quality.

The positions of the individual conference nodes in the conference bus must be communicated to them (k and N). This position can be dynamically altered. If a participant withdraws from the conference, then a new position must be communicated to each conference node.

The conference nodes are realized directly on the signal processors (DSP) of the subscriber units.

The primary advantages of the invention thus lie

In the realization of a service feature in the form of software, resulting in no manufacturing costs,

In additional open unit slots in the network, since no conference hardware is necessary. These unit slots can also be occupied with other units.

And in the unlimited number of conferences and conference participants in the system, since each subscriber can take part in a conference. Up until now, the number of conferences and conference participants has been limited by the hardware.

1. Process for realizing teleconferences in a switchboard network with a number (N) of active conference participants (KT₁ . . . KT_{N}), each of whom is connected via a subscriber unit to the switchboard network, characterized in that
the computation of the conference is implemented in each subscriber unit that forms a conference node (KK₁ . . . KK_{N}).

2. Process according to claim 1, characterized in that in each conference node (KK₁ . . . KK_{N}), from the blended user channel data for the active conference participants, the useful signal intended for the assigned conference participant (KKₖ) is taken from the conference bus, with weighting that corresponds to the total number of active participants present in the bus, is added, and is routed to the participant (KTₖ).

3. Process according to claim 1 or 2, characterized in that the signal for each conference participant (KTₖ) on the conference bus is added, whereby the bus signal in each conference node (KKₖ) is adjusted to correspond to the number of active participants (N), to maintain a maximum level.

4. Process according to one of the preceding claims, characterized in that via the bus system for each conference node, the current total number (N) of participants and the individual order number (k) is communicated.

5. Device for realizing teleconferences in a switchboard network with an undefined number (N) of conference participants (KT₁ . . . KT_{N}), each of whom is connected via a subscriber unit to the switchboard network, characterized in that
One or more conference nodes (KK₁ . . . KK_{N}) are assigned to each subscriber unit,
The conference nodes (KK₁ . . . KK_{N}) are connected to one another via a conference bus (KB), and
The conference nodes (KK₁ . . . KK_{N}) are realized as signal processor programs for computing the conference.
